(19) United States
(12) Patent Application Publication
(10) Pub. No.: US 2009/0032759 A1
(43) Pub. Date: Feb. 5, 2009

(54) Shut-off organ with anchored ceiling element

(76) Inventor: Hans-Jurgen Fehringer, Bochum (DE)

Correspondence Address: COLLARD & ROE, P.C., 1077 NORTHERN BOULEVARD, ROSLYN, NY, 11576, US

(21) Appl. No.: 12/221,439

(22) Filed: Aug. 1, 2008

(30) Foreign Application Priority Data
Aug. 2, 2007 (DE) 10 2007 036 244.9

(51) Int. Cl. F16K 1/22

(52) U.S. Cl. 251/306

(57) ABSTRACT

A shut-off organ for a fluid line, particularly for the turbine feed line of a hydroelectric power plant, has a housing and a clack valve in the housing that can be pivoted between an open position and a shut position. The clack valve has at least one swallowtail-shaped groove, into which an elastic sealing element having an essentially wedge-shaped cross-section that narrows towards the outside is laid. The sealing element rests against a conical sealing seat of the housing with its narrowed outer edge, forming a seal, in the shut position, thereby shutting off the shut-off organ. The possibility of the sealing element being sucked out is precluded even if the clack valve is opened while it stands under high hydraulic pressure, due to a rigid pin that extends through the sealing element essentially crosswise to the longitudinal expanse of the groove.

### CROSS REFERENCE TO RELATED APPLICATIONS

Applicant claims priority under 35 U.S.C. 119 of German Application No. 10 2007 036 244.9 filed Aug. 2, 2007.

### BACKGROUND OF THE INVENTION

1. Field of the Invention

The present invention relates to a shut-off organ for a fluid line, particularly for the turbine feed line of a hydroelectric power plant, having a housing and a clack valve in the housing that can be pivoted between an open position and a shut position. The clack valve has at least one swallowtail-shaped groove, into which an elastic sealing element having an essentially wedge-shaped cross-section that narrows towards the outside is laid. The sealing element rests against a conical sealing seat of the housing with its narrowed outer edge, forming a seal, in the shut position, thereby shutting off the shut-off organ.

2. The Prior Art

A shut-off organ of this type is described in German Patent No. DE 2 236 070. Shut-off organs serve to close off the flow cross-section of fluid lines—in other words pipes or hoses for liquid and/or gaseous media—in a stepless manner, all the way to a completely closed state. In this way, the mass throughput through the fluid line can be controlled by the angle position of the shut-off organ between an open position and shut position.

A hydroelectric power plant will be mentioned as an application example here. Its core is a turbine that recovers the flow energy of the water in order to drive a generator or another machine to rotate. If the shut-off organ is disposed in the turbine feed line, the volume stream through the turbine feed line and thus the power of the turbine can be controlled by adjusting the position of the clack valve. Of course, the shut-off organ can also be disposed in the region following the turbine, in order to control the turbine power by means of the amount of water that is flowing away. However, this is unusual in practice, since otherwise, the turbine would always be burdened with a water column, and this makes its maintenance more difficult.

Specifically in hydroelectric power plants, a high hydrostatic pressure of 25 bar is exerted on the clack valve of the shut-off organ when it is shut off. When the clack valve is pivoted to open, the hydraulic pressure is rapidly converted to flow energy. The accompanying pressure loss leads to significant stress on the sealing location of the shut-off organ, and in particular, on the sealing seat on the housing side and on the sealing element on the clack valve side. The high flow speed through the opening gap leads to cavitation erosion, which threatens to tear the sealing element out of the groove.

With the solution shown in DE 2 236 070, the sealing element, which is wedge-shaped in cross-section, is vulcanized into the swallowtail-shaped groove, or otherwise attached, in a manner not described in greater detail. Experience has shown that wedge-shaped sealing elements vulcanized into swallowtail-shaped grooves are not able to withstand the cavitation erosion that typically occurs when a hydroelectric turbine is started up, and they are sucked out of the groove. Complicated replacement of the sealing element is thus required. Another disadvantage of vulcanizing them in is that this joining method is only possible with rubber materials. Therefore the material selection for the seal is limited to rubber.

The seal assembly of a shut-off organ of a different type is described in German Patent No. DE 38 00 705 C2. This shut-off organ is intended for use in pipelines that conduct liquid and gaseous media at high and low temperatures, particularly in district heating networks or the like. For the seal assembly here, a sealing element in the form of a seal package of sealing rings stacked on top of one another is proposed, and elastic sealing rings alternate with metallic disks in the seal package. This seal assembly is sufficient for shutting off high-temperature media, but it is not able to withstand high hydrostatic pressures. This is due to the fact that the high hydraulic pressure bends the seal package, thereby causing significant shear forces to occur between the individual disks of the package. These shear forces lead to overly high stress at the adhesive locations, so that it must be feared that individual seal rings are torn out of the package. Another disadvantage of this seal assembly is the metallic contact between the metallic support rings and the sealing seat, which is brought about by the principle. In the case of frequent opening and closing, metallic friction wear at the surfaces must be expected here, causing the sealing effect to be impaired. Furthermore, the metallic sealing seat requires great dimensional stability of the sealing pair, since metallic sealing bodies are comparatively stiff and therefore cannot elastically balance out dimensional deviations like rubber seals. The great dimensional stability has an effect on the production precision to be adhered to, thereby increasing the production costs. For applications where high hydrostatic forces put stress on the shut-off organ, metallic sealing seats are completely unsuitable, since because of the great deformation of the clack valve under stress, the close seat precision cannot be accomplished. For example, the turbine lines of a hydroelectric power plant have nominal diameters of up to 2 meters, and the water column is present at 25 bar. This results in a force of 7.85 MN that places stress on the clack valve, corresponding to a weight force of a mass of 800 t. Hydraulic stresses of this magnitude can only be sealed off elastically.

A shut-off device of a different type, for a line that conducts gas, is described in German Patent No. DE 44 25 980 C2. Its sealing element comprises a metallic core onto which a covering of an elastic plastic material is applied. This shut-off organ is primarily conceived for gaseous fluids, and will therefore not withstand the pressure of a water column that is present in a hydroelectric power plant. Furthermore, the cavitation resistance of the seal is dependent on the adhesive connection between the elastic plastic sealing material and the metallic core.

### SUMMARY OF THE INVENTION

In view of this state of the art, it is an object of the invention to provide a shut-off organ of the type stated initially, in such a manner that the possibility of the sealing element being sucked out of the groove is precluded even if the clack valve is opened while it stands under high hydraulic pressure. It is another object of the invention to provide a shut-off organ where the configuration of the shut-off organ does not limit the material selection of the sealing element; metallic contact within the sealing location is to be avoided; the clack valve maintains a seal even under stress-related deformation; and finally, installation of the sealing element is facilitated.

These objects are accomplished in that at least one rigid pin is provided in the sealing element, which pin extends through the sealing element essentially crosswise to the longitudinal expanse of the groove.

The pin provided according to the invention is more rigid than the elastic seal material into which it is embedded. Because of the swallowtail shape of the groove, which narrows outward, the pin prevents the sealing element from being sucked out, with shape fit. The pin acts as an anchor for the sealing element. The tear-out resistance of the sealing element is therefore no longer determined by the adhesive force between the seal material and the metallic reinforcement element, but rather by the bending stiffness of the pin itself. Since the pin is embedded in the sealing element, it is additionally supported to prevent it from being bent out. Vulcanization between sealing element and clack valve is no longer necessary and the material selection is not limited in this regard. The sealing element can consist of rubber just as well as of PTFE.

Preferably, the length of the rigid pin is selected to be greater than the clear width of the groove. The clear width of the groove is understood to be the minimum width that it achieves at the outer circumference of the clack valve. If the pin is longer, the pin cannot be driven out.

However, it is also advantageous to dimension the pin not simply with any desired length, but rather smaller than the width of the sealing element, which it takes up on the radius on which the pin extends. The width of the ring-shaped sealing element decreases towards the outside, with an increasing radius, because of its wedge-shaped cross-section. If the sealing element is wider than the pin on the radius over which the pin extends, this means that the pin does not yet rest against the groove flanks in the unstressed state. A deformation of the seal element out of its unstressed state is not completely prevented in this way. Instead, a pin shortened in this manner allows slight radial expansion of the sealing element, so that the seal material is not subjected to overly great stress in the region of the pin.

Because of its swallowtail shape, the groove forms an undercut that makes it almost impossible to squeeze in the seal element reinforced with pins. In order to nevertheless allow installation of the seal element, it is recommended to divide the clack valve into a clack valve base body and at least one clamping ring braced to the latter, so that the one flank of the groove is formed by the clamping ring, and the other flank of the groove is formed by the clack valve base body. This configuration makes it possible to lay the sealing element into the opened groove of the clack valve base body after the clamping ring is removed, and to then close the groove by bracing the clack valve base body together with the clamping ring.

A preferred embodiment of the invention provides for configuring the sealing element so that a pressure medium can be applied to it from the groove base. By applying pressure to the sealing element from the groove base—in other words radially in the direction of the sealing seat—the pressing force of the sealing element against the sealing seat can be reinforced. It is even possible to permit a shut-off sealing seat only when pressure medium is applied to the sealing element. In this manner, it is possible to relieve stress on the seal when the clack valve is opened, in that first, the radial pressure from the inside is taken away from it, in order to pre-open the seal. Then the clack valve is pivoted open, in order to release the flow through it.

The application of pressure to a sealing element can be combined with a second sealing element that is switched in series with the first sealing element, in particularly advantageous manner. In this connection, only one of the two sealing elements must be equipped with the possibility of applying pressure, while the other sealing element always rests against the sealing seat of the housing in the closed position of the clack valve. In addition, one flank of the second groove should be formed, on the one hand, by the first clamping ring, which also flanks the first sealing element. The other flank of the second groove is then formed by the second clamping ring. In this way, an operational seal that can be replaced with relatively little effort is obtained, in the form of the second sealing element, while the first seal, to which pressure is applied, serves as a temporarily activated overhaul seal.

Anchoring using pins is particularly advantageous in the case of an “inflatable” overhaul seal, since when pressure medium is applied from the groove base, there is the risk of pressing the overhaul seal out of the groove if the application pressure is excessive. This is prevented by the pins.

The shut-off organ of the invention is excellently suited for closing off large-caliber fluid lines that carry liquid fluids at high pressures, in other words where a deformation of the clack valve is to be expected because of the high forces. What is meant here are lines having a cross-section between one and two meters and pressures around 25 bar. A particularly preferred use of the shut-off organ according to the invention relates to a hydroelectric power plant in which the shut-off organ is provided in the turbine feed line or, alternatively, in the region following the turbine.

Fundamentally, it is also possible to exchange the position of sealing element and sealing seat within the shut-off organ, so that sealing element and groove become an integral part of the non-moving housing, while the conical sealing seat becomes part of the moving clack valve.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows an axial face view of a shut-off organ according to an embodiment of the invention;

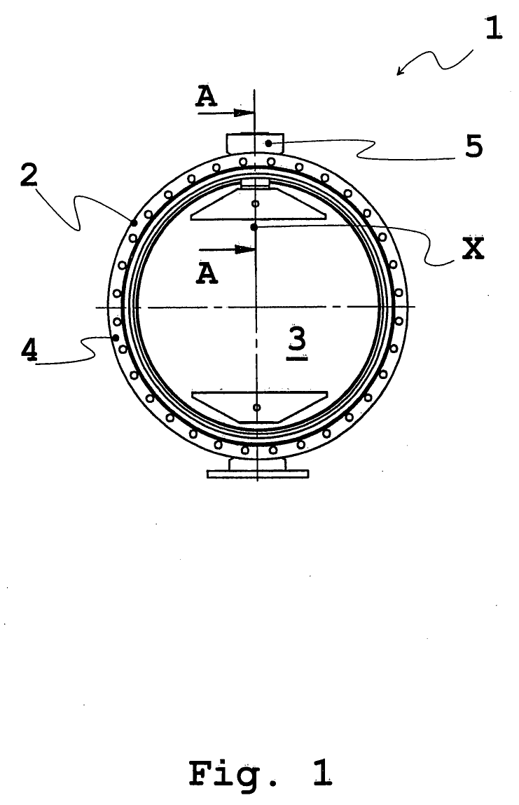

FIG. 2 shows a cross section along lines II-II of FIG. 1, of the sealing location of the shut-off organ.

### DETAILED DESCRIPTION OF THE PREFERRED EMBODIMENT

The shut-off organ according to the invention is designated, in its totality, with the reference numeral 1. Its essential components are a housing 2 and a clack valve 3 that is disposed in housing 2 so as to pivot around a pivot axis X. In an axial face view, clack valve 3 is circular. Housing 2 is connected with a pipeline, not shown here, by way of a flange 4, so that the passage cross-section of shut-off organ 1 can be adjusted in a stepless manner, by pivoting clack valve 3 about pivot axis X. Pivoting of clack valve 3 takes place by a pivot drive 5, which is not shown.

On its inside circumference, housing 2 is provided with a conical sealing seat 6. Clack valve 3 is disposed within the sealing seat 6. Clack valve 3 is attached to a pivot shaft 7, which extends along pivot axis X and is rotated by pivot drive 5. Clack valve 3 itself is formed from a clack valve base body 8, with which a first clamping ring 9 and a second clamping ring 10 are braced together.

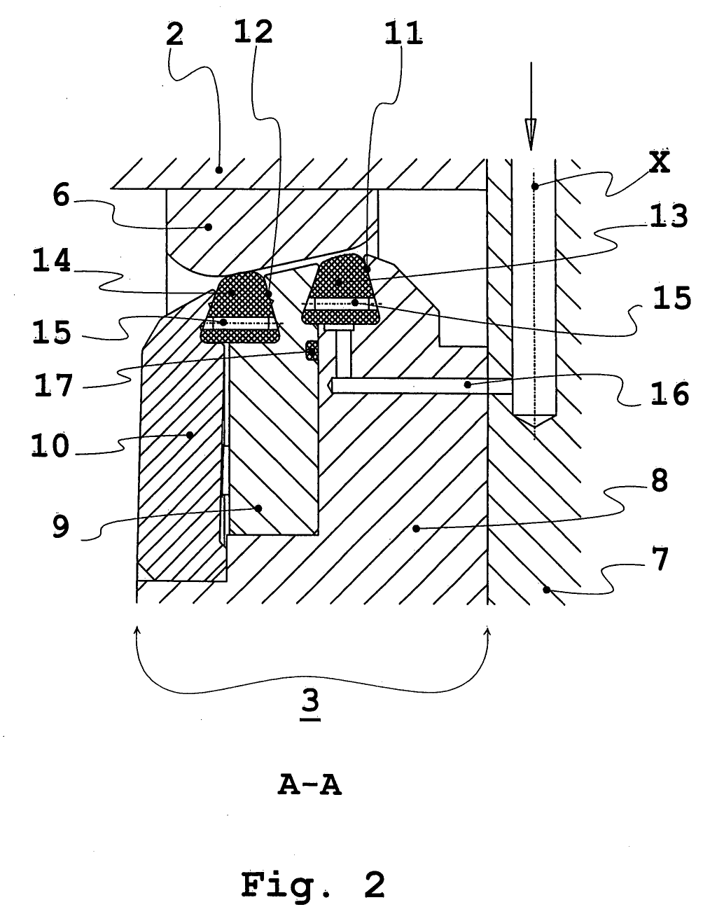

On its outside circumference, towards sealing seat 6, clack valve 3 is provided with two grooves 11, 12, which extend in a ring shape along the outside circumference of clack valve 3. Grooves 11, 12 are structured essentially in swallowtail shape in cross-section, cf. FIG. 2. This means that the width of grooves 11, 12 decreases radially towards the outside. The grooves have their smallest width, in other words their clear width, at the outer edge of clack valve 3 that faces the sealing seat 6, in each instance. The flanks of grooves 11, 12 are formed by different components of clack valve 3, in each instance: The right flank of first groove 11 is formed by clack valve base body 8; the left flank of first groove 11 and the right flank of second groove 12 are formed by first clamping ring 9; finally, the left flank of second groove 12 is formed by second clamping ring 10. Due to the distribution of the groove flanks among the different components 8, 9, 10 of clack valve 3, as just described, it is possible to lay seal elements 13, 14 into grooves 11, 12 despite the undercuts that result from the swallowtail shape of grooves 11, 12. The internal seal of clamping rings 9, 10 takes place by way of a standard round sealing ring 17, which is disposed between the clack valve base body 8 and first clamping ring 9.

Seal elements 13, 14 also extend in ring shape along the groove, around clack valve 3, and are essentially wedge-shaped in cross-section, so that they narrow radially outward. The wedge angle of seal elements 13, 14 corresponds to the swallowtail angle of grooves 11, 12, so that seal elements 13, 14 are held in grooves 11, 12 with a shape fit. In addition, the sealing element has a slight excess dimension, thereby seating it in the groove with elastic bias.

In order to prevent sealing elements 13, 14 from being sucked out of grooves 11, 12 when clack valve 3 is opened, both sealing elements 13, 14 are filled with a plurality of rigid pins 15. Pins 15 are cylindrical metal pins that extend axially through the seal element 13, in other words crosswise to the longitudinal expanse of the groove 11, i.e. of the element. Pin 15 extends essentially crosswise to the longitudinal expanse of groove 11, i.e. axially relative to shut-off organ 1, and perpendicular to the radial direction of shut-off organ 1. The position information relating to pin 15 with reference to the shut-off organ 1 applies in the shut-off position. In the sectional representation shown in FIG. 2, only one rigid pin 15 can be seen in each sealing element, in each instance, but in fact, a plurality of cylindrical pins are distributed along the two ring-shaped seal elements 13, 14, at a constant angle distance from one another.

Pin 15 is inserted into a corresponding channel of seal element 13, and thus surrounded by the elastic seal material. Its length is selected to be greater than the clear width of the groove 11, so that it is not possible to drive sealing element 13 out radially. At the same time, its length is selected to be somewhat shorter than the width of sealing element 13 on the corresponding radius. This means that the bore into which pin 15 is inserted is longer than pin 15 itself. Pin 15, shortened in this manner, allows a certain radial expansion, in the direction of sealing seat 6, in sealing element 13. However, the radial expansion of sealing element 13 is limited by pin 15.

The seal assembly shown in FIG. 2 comprises two sealing elements 13, 14, switched in parallel, whereby first seal element 13 is provided upstream, as an overhaul seal, and second seal element 14, downstream, functions as an operational seal. Overhaul seal 13 can have a pressure medium such as water applied to it from the groove base, by means of a pressure channel 16 that is passed through pivot shaft 7 and clack valve base body 8. Without radial application of pressure to first sealing element 13, the overhaul seal does not lie against sealing seat 6 even in the shut-off position of the clack valve, so that its sealing effect is deactivated. When deactivated, first sealing element 13 is retracted far into its groove 11, so that it experiences hardly any wear. The operational seal, on the other hand, is always guaranteed by way of second seal element 14, which rests against the sealing seat, forming a seal, when clack valve 3 is closed.

The double sealing assembly with an overhaul seal that can be activated separately makes it possible to replace operational seal 14 while a water column is present. For this purpose, the overhaul seal is activated, while clack valve 3 is closed, in that first sealing element 13 has a pressure medium applied to it by way of pressure line 16. In this connection, the pins 15 in overhaul seal 13 prevent first sealing element 13 from being driven out of first groove 11 by means of excessive medium pressure. Operational seal 14 is relieved of stress by activating the overhaul seal 13. Consequently, second clamping ring 10 can be unscrewed from the dry side of clack valve 3, and second seal element 14 can be replaced. After re-installation of second clamping ring 10, first seal element 13 can be deactivated again, so that the seal function from then on is taken over by replaced seal element 14.

Accordingly, while only a few embodiments of the present invention have been shown and described, it is obvious that many changes and modifications may be made thereunto without departing from the spirit and scope of the invention.

What is claimed is:

1. A shut-off organ for a fluid line, comprising:
a housing;
a clack valve in the housing, said clack valve being pivotable between an open position and a shut position, and having at least one swallowtail-shaped groove;
an elastic sealing element having a substantially wedge-shaped cross-section that narrows towards an outside, said sealing element being disposed in said groove and resting against a conical sealing seat of the housing with its narrowed outer edge, forming a seal, in the shut position, thereby shutting off the shut-off organ; and
at least one rigid pin extending through the sealing element substantially crosswise to a longitudinal expanse of the groove.

2. The shut-off organ according to claim 1, wherein a length of the rigid pin is greater than a clear width of the groove.

3. The shut-off organ according to claim 1, wherein a length of the rigid pin is smaller than a width of the sealing element at a radius on which the pin extends.

4. The shut-off organ according to claim 1, wherein the clack valve comprises a clack valve base body and at least one clamping ring braced to the clack valve base body, wherein one flank of the groove is formed by the clamping ring, and another flank of the groove is formed by the clack valve base body.

5. The shut-off organ according to claim 1, wherein the sealing element has a pressure medium applied to it from a groove base.

6. The shut-off organ according to claim 4,
wherein the clack valve has a second swallowtail-shaped groove, into which a second elastic sealing element having an essentially wedge-shaped cross-section that narrows towards the outside is laid, said second sealing element resting against the conical sealing seat of the housing with its narrowed outer edge, forming a seal, in the shut position, to shut off the shut-off organ,
wherein the clack valve comprises a second clamping ring that is braced together with the first clamping ring and with the clack valve base body, and
wherein one flank of the second groove is formed by the second clamping ring, and another flank of the second groove is formed by the first clamping ring.

7. A method for shutting off a fluid line having a nominal diameter of about 1 meter to about 2 meters, at a pressure of about 25 bar, the fluid line having a shut-off valve comprising:
a housing;
a clack valve in the housing, said clack valve adapted to be pivoted between an open position and a shut position, and having at least one swallowtail-shaped groove;
an elastic sealing element having an essentially wedge-shaped cross-section that narrows towards the outside disposed in said groove; and
at least one rigid pin extending through the sealing element substantially crosswise to a longitudinal expanse of the groove, the method comprising shutting the sealing element so that the sealing element rests against a conical sealing seat of the housing with its narrowed outer edge, forming a seal to shut off the fluid line.

8. A hydroelectric power plant having a turbine for recovering the flow energy of the water, and having a turbine feed line through which the water flows to the turbine, wherein a shut-off organ according to claim 1 is disposed in the turbine feed line, so that the turbine feed line can be shut off by the shut-off organ.
